(19) United States
(12) Patent Application Publication
(10) Pub. No.: US 2014/0013030 A1
(43) Pub. Date: Jan. 9, 2014

(54) MEMORY STORAGE DEVICE, MEMORY CONTROLLER THEREOF, AND METHOD FOR WRITING DATA THEREOF

(71) Applicant: PHISON ELECTRONICS CORP., Miaoli (TW)

(72) Inventor: Chih-Kang Yeh, Kinmen County (TW)

(73) Assignee: PHISON ELECTRONICS CORP., Miaoli (TW)

(21) Appl. No.: 13/632,167

(22) Filed: Oct. 1, 2012

(30) Foreign Application Priority Data
Jul. 3, 2012 (TW) 101123898

(51) Int. Cl. G06F 12/00

(52) U.S. Cl. 711/103; 711/E12.008

(57) ABSTRACT

A method for writing data is provided, including: configuring multiple logical programming units for mapping to a portion of the physical programming units in the rewritable non-volatile memory module, and dividing each logical programming unit into multiple logical management units, wherein a size of each logical management unit is identical to a basic access unit of a host system. The method includes: receiving a first data from the host system, determining whether a logical start address of the first data is not aligned to a start address of each logical management unit within the first logical programming unit and/or determining whether a logical end address of the first data is not aligned to an end address of each logical management unit within the first logical programming unit. If the determination result is positive, filling the first data by using a second data which is larger than the basic access unit.

### CROSS-REFERENCE TO RELATED APPLICATION

This application claims the priority benefit of Taiwan application serial no. 101123898, filed on Jul. 3, 2012. The entirety of the above-mentioned patent application is hereby incorporated by reference herein and made a part of this specification.

### BACKGROUND OF THE INVENTION

1. Field of the Invention

The invention relates to a method for writing data, and more particularly, to a method for writing data in a rewritable non-volatile memory module, and a memory storage device and a memory controller using the same.

2. Description of Related Art

Rewritable non-volatile memory is one of the most adaptable memories for portable electronic products such as digital camera, cell phone and MP3 player due to its data non-volatility, low power consumption, small volume and non-mechanical structure. A solid state drive is a storage device adopting flash memory as storage medium.

Generally, a flash memory module of a flash memory storage device is divided into a plurality of physical blocks, in which the physical blocks are further divided into a plurality of physical pages. In the flash memory, the physical block is an erasing unit and the physical page is a writing unit. Since only unidirectional programming (i.e., by programming the value of the memory cell from 1 to 0) may be performed to programming memory cells of the flash memory, a direct writing to a programmed physical page (i.e., page that is stored with old data) may not be performed before such physical page has been erased for re-programming. In particular, since the physical block is used as a unit for erasing, when an erasing operation is performed to the physical page stored with old data, the physical block that contains the physical page is erased entirely. Therefore, the physical blocks of the flash memory module are divided into a data area and a spare area, in which the physical blocks in the data area are physical blocks already stored with data and the physical blocks in the spare area are physical blocks not being used. In which, when the host system is intended to write data into the flash memory storage device, the physical block in the spare area are accessed by the control circuit of the flash memory storage device for writing data, and the physical blocks being accessed are related to the data area. In addition, after an erasing operation to the physical blocks of the data area is performed, the physical blocks being erased are related to the spare area.

Traditional flash memory module uses a physical page as a basic access unit for data accessing. However, a size of a basic access unit in a host system nowadays may be smaller than a size of one physical page. For example, if the size of the physical page is 16 kilobyte (KB) and the basic access unit thereof is 4 KB, a controller of the flash memory storage device may temporarily store the data in a buffer unit of the flash memory module when a writing instruction (in which each set of data is 4 KB) is issued from the host system. Once the data which the host system intended to write in reaches 16 KB, said data is then programmed into the physical page. In this case, a program time may be used for processing four sets of data.

Although said method may increase the speed of writing data, in the case where the host system intended to read a great amount of data, the reading operation thereof may cost more time in processing due to data being spread among different physical pages.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY OF THE INVENTION

Accordingly, the invention is directed to a method for writing data, a memory controller and a memory storage device using the same, which may effectively increase the speed of reading data in the follow-up operations.

The invention provides a method for writing data, adapted for a rewritable non-volatile memory module, the rewritable non-volatile memory module has multiple of physical erasing units, and each physical erasing unit has multiple physical programming units. The method includes configuring multiple logical programming units for mapping to a portion of the physical programming units in the rewritable non-volatile memory module, and dividing each logical programming unit into multiple logical management units, in which a size of each logical management unit is identical to a basic access unit of a host system. The method further includes receiving a first data from the host system, wherein the first data is written into a first logical programming unit among said logical programming units. The method further includes determining whether a logical start address of the first data is not aligned to a start address of each logical management unit within the first logical programming unit and/or determining whether a logical end address of the first data is not aligned to an end address of each logical management unit within the first logical programming unit. If a result to the foregoing determination is positive, the method further includes: filling the first data by using a second data which is larger than the basic access unit to generate a write data, and writing the write data into at least one of the physical programming units.

From another perspective, the invention provides a memory controller, adapted for a memory storage device having a rewritable non-volatile memory module, the memory controller includes a host system interface, a memory interface and a memory management circuit. In which, the host system interface is configured for coupling to a host system. The memory interface is configured for coupling to the rewritable non-volatile memory module, in which the rewritable non-volatile memory module has multiple physical erasing units, and each physical erasing unit has multiple physical programming units. The memory management circuit is coupled to the host system interface and the memory interface and configured for configuring multiple logical programming units for mapping to a portion of the physical programming units in the rewritable non-volatile memory module, and dividing each logical programming unit into multiple logical management units, in which a size of each logical management unit is identical to a size of a basic access unit of the host system. The memory management circuit is further used for receiving a first data from the host system, in which the first data is written into a first logical programming unit among said logical programming units. The memory management circuit is further used for determining whether a logical start address of the first data is not aligned to a start address of each logical management unit within the first logical programming unit and/or determining whether a logical end address of the first data is not aligned to an end address of each logical management unit within the first logical programming unit. If a result to the foregoing determination is positive, the memory management circuit is further used for filling the first data by using a second data which is larger than the basic access unit to generate a write data, and writing the write data into at least one of the physical programming units.

From yet another aspect, the invention provides a memory storage device, which includes a rewritable non-volatile memory module, a connector and a memory controller. In which, the rewritable non-volatile memory module has multiple physical erasing units, in which each physical erasing units has multiple physical programming units. The connector is coupled to a host system. The memory controller is coupled to the rewritable non-volatile memory module and the connector and configured for configuring multiple logical programming units for mapping to a portion of the physical programming units in the rewritable non-volatile memory module, and dividing each logical programming unit into multiple logical management units, wherein a size of each logical management unit is identical to a size of a basic access unit of the host system, In which, the memory controller is further used for receiving a first data from the host system, the first data is written into a first logical programming unit among said logical programming units. In which, the memory controller is further used for determining whether a logical start address of the first data is not aligned to a start address of each logical management unit within the first logical programming unit and/or determining whether a logical end address of the first data is not aligned to an end address of each logical management unit within the first logical programming unit. If a result to the foregoing determination is positive, the memory controller is further used for filling the first data by using a second data which is larger than the basic access unit to generate a write data, and writing the write data into at least one of the physical programming units.

As described above, when the data which the host system is intended to write is not aligned to any start and end address of the logical management unit, a method for writing data, a memory controller and a memory storage device in exemplary embodiments of the invention may fill the data by using another a second data which is larger than the basic access unit of a host system, and write the filled data into the rewritable non-volatile memory module. As a result, a speed of reading data from the rewritable non-volatile memory module in the follow-up operations may be increased.

To make the above features and advantages of the invention more comprehensible, several embodiments accompanied with drawings are described in detail as follows.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

FIG. 1A is a schematic diagram of a host system using memory storage device according to an exemplary embodiment of the invention.

FIG. 1B is a schematic diagram of a computer, an input/output device, and a memory storage device according to an exemplary embodiment of the invention.

FIG. 1C is a schematic diagram of a host system and a memory storage device according to another exemplary embodiment of the invention.

FIG. 2 is a schematic block diagram of the memory storage device in FIG. 1A.

FIG. 3 is a schematic block diagram of a memory controller according to an exemplary embodiment of the invention.

FIG. 4 and FIG. 5 are schematic diagrams illustrating management of a rewritable non-volatile memory module according to an exemplary embodiment of the invention.

FIG. 6 is a schematic diagram illustrating a logical programming unit according to an exemplary embodiment of the invention.

FIGS. 7, 8, 9, 10 are schematic diagrams illustrating writing a first data to a logical programming unit according to an exemplary embodiment of the invention.

FIG. 11 is a flowchart illustrating a method for writing data according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally, a memory storage device (a.k.a. the memory storage system) includes a rewritable non-volatile memory module and a controller (a.k.a. the control circuit). The memory storage device is usually configured together with a host system so that the host system may write data into or read data from the memory storage device.

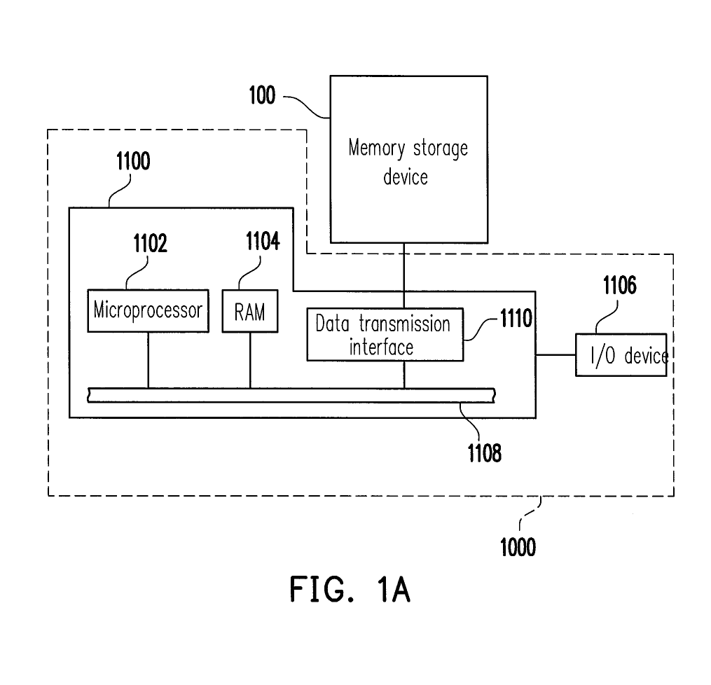

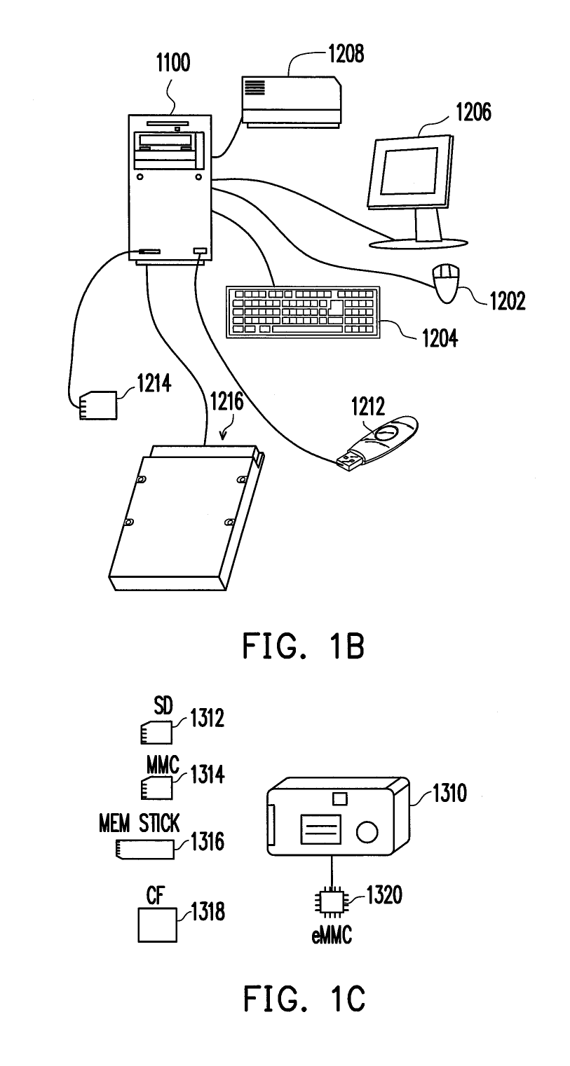

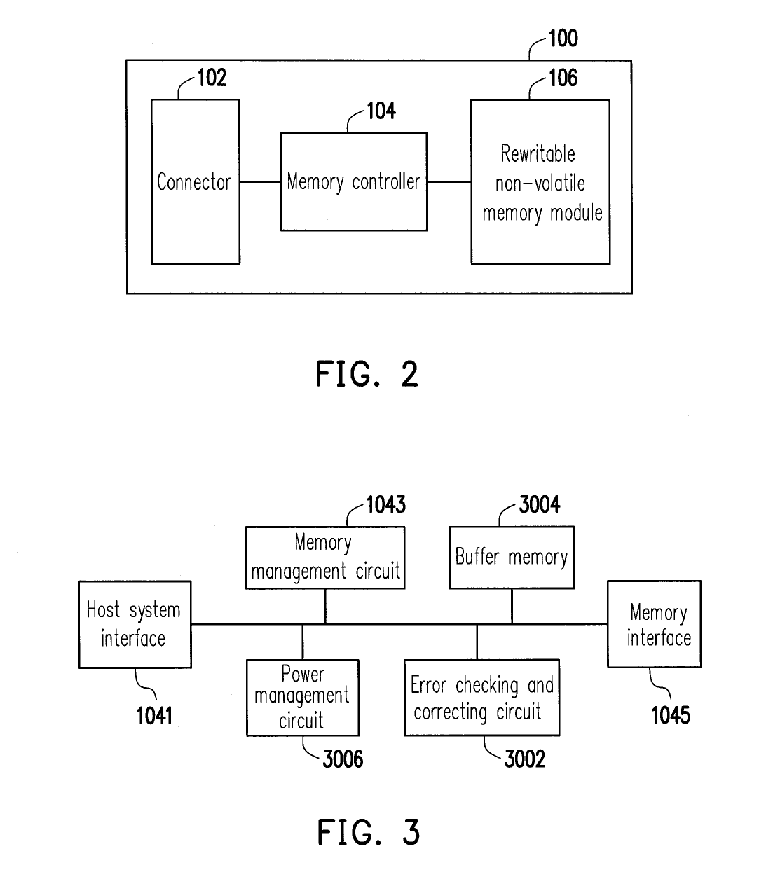

FIG. 1A is a schematic diagram of a host system using memory storage device according to an exemplary embodiment of the invention.

The host system 1000 includes a computer 1100 and an input/output (I/O) device 1106. The computer 1100 includes a microprocessor unit 1102, a random access memory (RAM) 1104, a system bus 1108, and a data transmission interface 1110. The I/O device 1106 includes a mouse 1202, a keyboard 1204, a display 1206 and a printer 1208 as shown in FIG. 1B. It should be understood that the devices illustrated in FIG. 1B are not intended to limit the I/O device 1106, and the I/O device 1106 may further include other devices.

In the exemplary embodiment of the invention, the memory storage device 100 is coupled to other devices of the host system 1000 through the data transmission interface 1110. By using the microprocessor 1102, the random access memory 1104 and the Input/Output device 1106, the host system 1000 may write data into or read from the memory storage device 100. For example, the memory storage device 100 may be a memory card 1214, a flash drive 1212, or a solid state drive (SSD) 1216 as shown in FIG. 1B.

Generally, the host system 1000 may be any system capable of storing data. Although the present exemplary embodiment is described using a computer system as the host system 1000, in another exemplary embodiment of the invention, the host system 1000 may also be a cell phone, a digital camera, a video camera, a telecommunication device, an audio player or a video player. For example, when the host system is a digital camera 1310, the memory storage device being used may be a SD (Secure Digital) card 1312, a MMC (Multimedia Card) card 1314, a memory stick 1316, a CF (Compact Flash) card 1318 or an embedded storage device 1320 (as shown in FIG. 1C). The embedded storage device 1320 includes an embedded MMC (eMMC). It should be mentioned that the eMMC is directly coupled to a substrate of the host system.

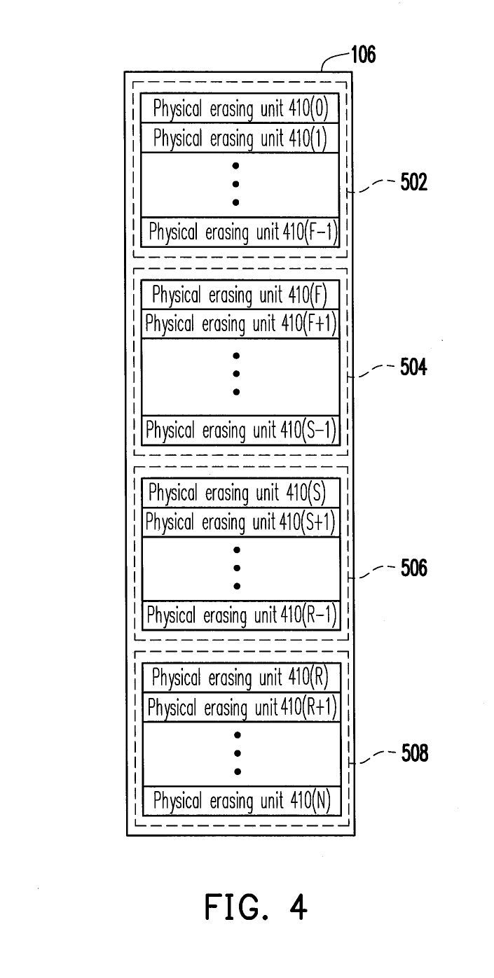

FIG. 2 is a block diagram of the memory storage device 100 in FIG. 1A. Referring to FIG. 2, the memory storage device 100 includes a connector 102, a memory controller 104 and a rewritable non-volatile memory module 106.

The connector 102 is coupled to the memory controller 104 and configured for coupling to the host system 1000. In the present exemplary embodiment, the type of data transmission interface supported by the connector 102 is serial advanced technology attachment (SATA) interface. However, in other exemplary embodiments, the connector 102 may also be a Parallel Advanced Technology Attachment (PATA) interface, an Institute of Electrical and Electronic Engineers (IEEE) 1394 interface, a peripheral component interconnect (PCI) Express interface, a universal serial bus (USB) standard, a secure digital (SD) interface, a Ultra High Speed-I (UHS-I) interface, a Ultra High Speed-II (UHS-II) interface, a memory stick (MS) interface, a multi media card (MMC) interface, an embedded MMC (eMMC) interface, a Universal Flash Storage (UFS) interface, a compact flash (CF) interface, an integrated device electronics (IDE) interface or other suitable interfaces, the invention is not limited thereto.

The memory controller 104 executes a plurality of logic gates or control commands which are implemented in a hardware form or in a firmware form, so as to perform operations of writing, reading or erasing data in the rewritable non-volatile memory storage module 106 according to the commands of the host 1000. In which, the memory controller 104 processes data that the host system 1000 intended to write into the rewritable non-volatile memory module 106 based on the method for writing data according to the present exemplary embodiment. The method for writing data of the present exemplary embodiment is described below with reference of accompanying drawings.

The rewritable non-volatile memory module 106 is coupled to the memory controller 104. The rewritable non-volatile memory module 106 is a Multi Level Cell (MLC) NAND flash memory module, but the invention is not limited thereto. The rewritable non-volatile memory module 106 may also be a Single Level Cell (SLC) NAND flash memory module, other flash memory modules or any memory module having the same features. Furthermore, the rewritable non-volatile memory module 106 includes a plurality of physical erasing units, in which each physical erasing unit has a plurality of physical programming units. The physical programming units belonged to the same physical erasing unit may be written into separately and erased simultaneously. That is, the physical erasing unit is the minimum unit for erasing. Namely, each physical erasing unit contains the least number of memory cells to be erased together. The physical programming unit is the minimum unit for programming. That is, the physical programming unit is the minimum unit for writing data. In an exemplary embodiment, the physical erasing unit is a physical block, and the physical programming unit is a physical page or a physical sector, but the invention is not limited thereto.

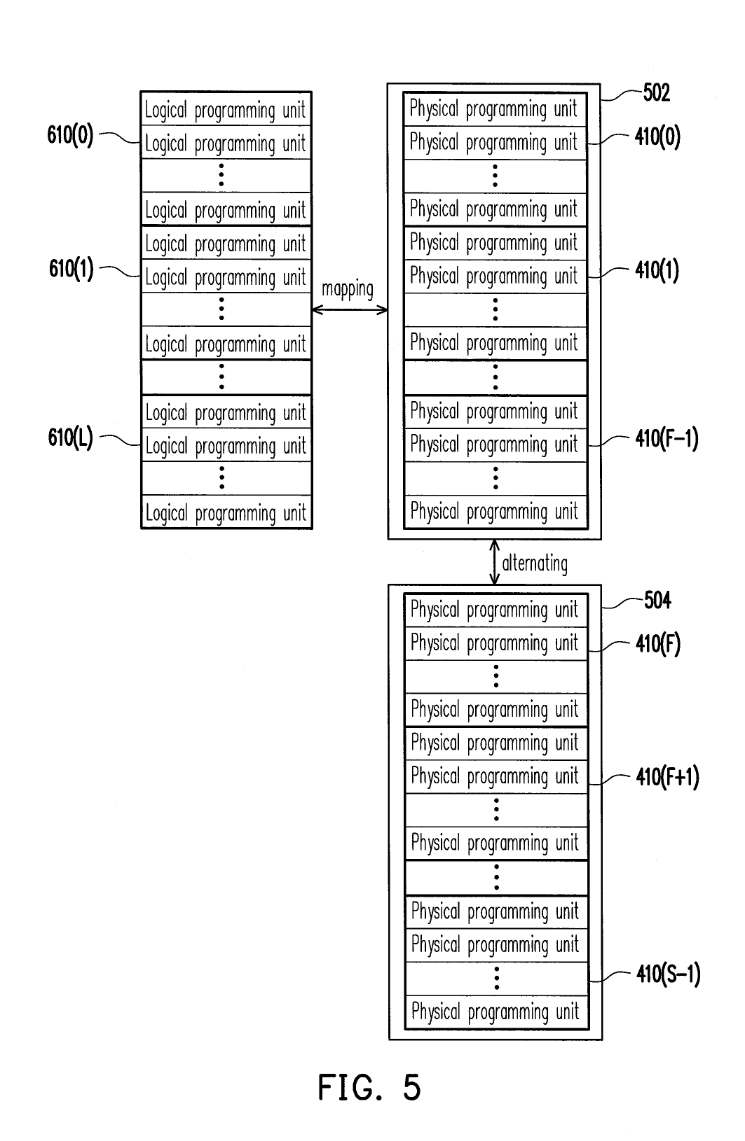

FIG. 3 is a schematic block diagram of a memory controller according to an exemplary embodiment of the invention. Referring to FIG. 3, the memory controller 104 includes a host system interface 1041, a memory management circuit 1043 and a memory interface 1045.

The host system interface 1041 is coupled to the memory management circuit 1043, and configured for coupling to the host system 1000 through the connector 102. The host system interface 1041 is configured for receiving and identifying commands and data sent from the host system 1000. In this case, the commands and data sent from the host system 1000 are passed to the memory management circuit 1043 through the host system interface 1041. In the present exemplary embodiment, the host system interface 1041 is a SATA interface for corresponding to the connector 102. In other exemplary embodiments, the host system interface 1041 may also be a USB interface, an MMC interface, a PATA interface, an IEEE 1394 interface, a PCI Express interface, a SD interface, a UHS-I interface, a UHS-II interface, an MS interface, a CF interface, a UFS interface, an IDE interface, or other suitable interfaces.

The memory management circuit 1043 is configured for controlling the overall operations of the memory controller 104. More specifically, the memory management circuit 1043 has a plurality of control commands, the control commands are executed to implement the method for writing data of the present exemplary embodiment when the memory storage device 100 is powered on.

In an exemplary embodiment, the control commands of the memory management circuit 1043 are implemented in a form of a firmware. For example, the memory management circuit 1043 has a microprocessor unit (not illustrated) and a ROM (not illustrated), and the control commands are burned into the ROM. During the operation of the memory storage device 100, the control commands are executed by the microprocessor unit to implement the method for writing data of the present exemplary embodiment.

In another exemplary embodiment of the invention, the control commands of the memory management circuit 1043 may also be stored as program codes in a specific area (for example, the system area in the rewritable non-volatile memory module 106 exclusively used for storing system data) of the rewritable non-volatile memory module 106. In addition, the memory management circuit 1043 has a microprocessor unit (not illustrated), a ROM (not illustrated) and a RAM (not illustrated). In which, the ROM has an activate code segment, which is executed by the microprocessor unit to load the control commands stored in the rewritable non-volatile memory module 106 to the RAM of the memory management circuit 1043 when the memory controller 104 is enabled. Next, the control commands are executed by the microprocessor unit to implement the method for writing data of the present exemplary embodiment.

Further, in another exemplary embodiment of the invention, the control commands of the memory management circuit 1043 may also be implemented in a form of a hardware. For example, the memory management circuit 1043 includes a microprocessor, a memory management unit, a memory writing unit, a memory reading unit, a memory erasing unit and a data processing unit. The memory management unit, the memory writing unit, the memory reading unit, the memory erasing unit and the data processing unit are coupled to the microprocessor. In which, the memory management unit is configured for managing the physical erasing unit in the rewritable non-volatile memory module 106. The memory writing unit is configured for providing a writing command to the rewritable non-volatile memory module 106, thereby writing data into the rewritable non-volatile memory module 106. The memory reading unit is configured for providing a reading command to the rewritable non-volatile memory module 106, thereby reading data from the rewritable non-volatile memory module 106. The memory erasing unit is configured for providing an erasing command to the rewritable non-volatile memory module 106, thereby erasing data from the rewritable non-volatile memory module 106. The memory processing unit is configured for processing data to be written into the rewritable non-volatile memory module 106 and data read from the rewritable non-volatile memory module 106.

The memory interface 1045 is coupled to the memory management circuit 1043 and configured for coupling the memory controller 104 and the rewritable non-volatile memory module 106. In this case, the memory controller 104 may perform related operations to the rewritable non-volatile memory module 106. That is, data to be written into the rewritable non-volatile memory module 106 is converted to a format acceptable to the rewritable non-volatile memory module 106 through the memory interface 1045.

In another exemplary embodiment of the invention, the memory controller 104 further includes an error checking and correcting unit 3002. The error checking and correcting circuit 3002 is coupled to the memory management circuit 1043 and configured for performing an error checking and correcting process to ensure the correctness of data. Specifically, when a writing command from the host system 1000 is received by the memory management circuit 1043, the error checking and correcting circuit 3002 generates an error checking and correcting code (ECC code) for data corresponding to the writing command, and the memory management circuit 1043 writes the data and the ECC code corresponding to the writing command into the rewritable non-volatile memory module 106. Next, when reading data from the rewritable non-volatile memory module 106, the memory management circuit 1043 also reads the ECC Code corresponding to such data, and the error checking and correcting circuit 3002 performs an error checking and correcting process to the read data based on the read ECC code, so as to identify whether data has error bits.

In another exemplary embodiment of the invention, the memory controller 104 further includes a buffer memory 3004. The buffer memory 3004 may be a static random access memory (SRAM) or a dynamic random access memory (DRAM), the invention is not limited thereto. The buffer memory 3004 is coupled to the memory management circuit 1043 and configured for temporarily storing commands and data from the host system 1000 or data from the rewritable non-volatile memory module 106.

In yet another exemplary embodiment of the invention, the memory controller 104 further includes a power management circuit 3006. The power management unit 3006 is coupled to the memory management circuit 1043 and configured for controlling the power of the memory storage device 100.

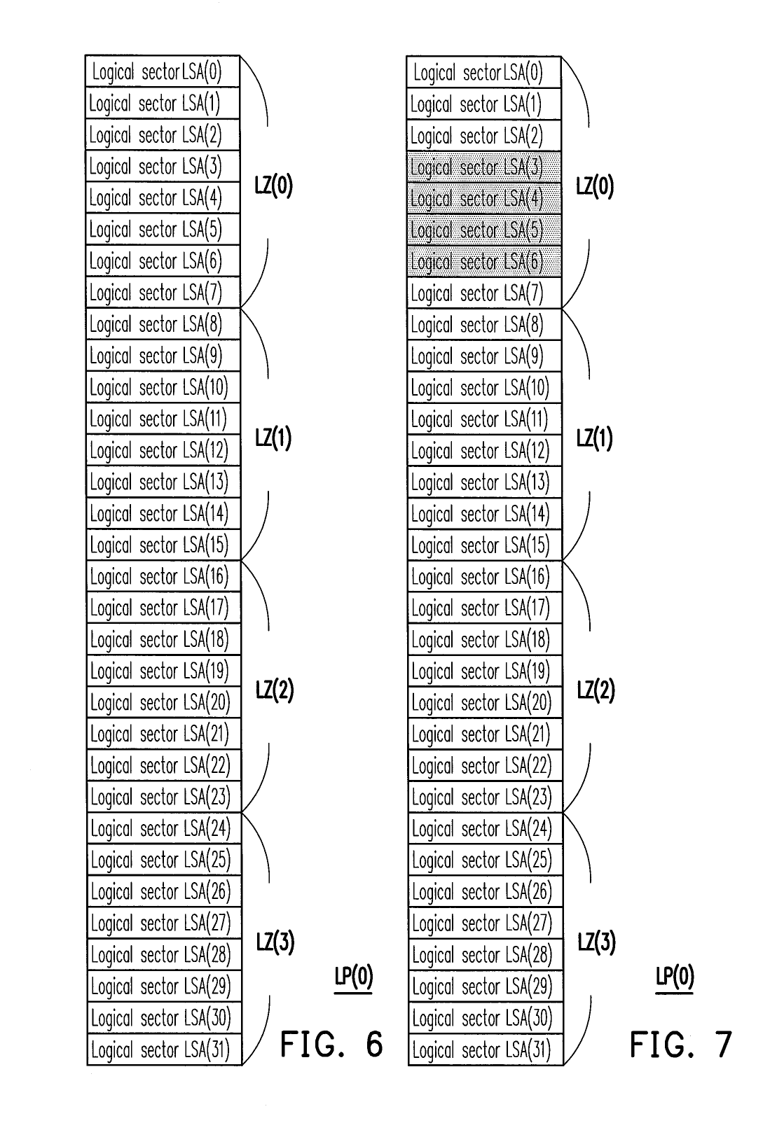

FIG. 4 and FIG. 5 are schematic diagrams illustrating management of a rewritable non-volatile memory module according to an exemplary embodiment of the invention.

The terms, such as “retrieve”, “exchange”, “group”, “alternate” and so forth, are logical concepts which describe operations in the physical erasing units of the rewritable non-volatile memory module 106. Namely, the actual positions of the physical erasing units in the rewritable non-volatile memory module 106 are not changed. Instead, said operations in the physical erasing units of the rewritable non-volatile memory module 106 are only logically performed.

Referring to FIG. 4, the rewritable non-volatile memory module 106 includes physical erasing units 410(0) to 410(N). The memory management circuit 1043 in the memory controller 104 logically groups the physical erasing units 410(0) to 410(N) into a data area 502, a spare area 504, a system area 506 and a replacement area 508. In which, marks F, S, R and N as illustrated in FIG. 4 are positive integers, which represent a number of the physical erasing units configured in each area, and may be varied based on a size of the rewritable non-volatile memory module 106 used by the manufacturer of the memory storage system 100.

Logically, the physical erasing units belonged to the data area 502 and the spare area 504 are configured for storing data from the host system 1000. For example, the physical erasing units of the spare area 502 is regarded as the physical erasing units that have been stored with data, whereas the physical erasing units of the spare area 504 are physical erasing units configured for writing new data. In other words, the physical erasing units of the spare area 504 are either blank or available physical erasing units (i.e., no data recorded or data marked as invalid). When receiving a writing command and data from the host system 1000, the memory management unit 1043 retrieves a physical erasing unit from the spare area 504 and writes data into the retrieved physical erasing unit, so as to replace the physical erasing unit in the data area 502. Alternatively, when a required data merging operation to a logical erasing unit is performed, the memory management circuit 1043 retrieves a physical erasing unit from the spare area 504 and writes data therein, so as to replace to the physical erasing unit previously mapped with said logical erasing unit.

The physical erasing units logically belonged to the system area 506 is configured for recording system data. For example, system data includes information related to manufacturer and model of the rewritable non-volatile memory module 106, the number of physical erasing units in the rewritable non-volatile memory module 106, the number of the physical programming unit in each physical erasing unit, and so forth.

When a physical erasing unit in the data area 502, the spare area 504 or the system area 506 is damaged, the physical erasing unit logically belonged to the replacement area 508 is for replacing the such damaged physical erasing unit. More specifically, during the operation of the memory storage device 100, if there are still available physical erasing units in the replacement area 508 in the case where the physical erasing unit in the data area 502 is damaged, the memory management circuit 1043 retrieves an available physical erasing unit from the replacement area 508 for replacing the damaged physical erasing unit in the data area 502. If there is no more available physical erasing unit in the replacement area 508 when a physical erasing unit is damaged, the memory storage device 100 is announced by the memory management circuit 1043 as being in a write-protect status, and data cannot be written therein.

Therefore, during the operation of the memory storage device 100, the physical erasing units of the data area 502, the spare area 504, the system area 506 and the replacement area 406 may be dynamically changed. For example, the physical erasing units used for storing data alternately may be dynamically belonged to the data area 502 or the spare area 504.

Referring to FIG. 5, the memory management circuit 1043 configures a plurality of logical erasing units 610(0) to 610(L) for mapping to the physical erasing units 410(0) to 410(F−1) in the data area 502, so that the host system 1000 may access the rewritable non-volatile memory module 106. In which, each logical erasing unit includes a plurality of logical programming units, and the logical programming units within the logical erasing units 610(0) to 610(L) are mapped to the physical programming units within the physical erasing units 410(0) to 410(F−1).

More specifically, the memory management circuit 1403 provides the configured logical erasing units 610(0) to 610(L) to the host system 1000, and maintains a logical address-physical address mapping table for recording the mapping relations of the logical erasing unit 610(0) to 610(L) and the physical erasing units 410(0) to 410(F−1). Therefore, when the host system 1000 is intended to access a logical address, the memory management circuit 1043 confirms the logical erasing units and logical programming units that are corresponding to the logical address, and searches a physical programming units mapped thereto through the logical address-physical address mapping table for accessing.

In the present exemplary embodiment, each logical programming unit configured by the memory management circuit 1043 is composed by a plurality of logical sectors, the logical sectors in the logical programming unit are corresponding to the physical sectors in the physical programming unit. The memory management circuit 1403 divides the logical sectors into a plurality of logical management units, in which a size of each logical management unit is identical to a size of a basic access unit of the host system 1000.

For example, it is assumed that each logical programming unit has 32 logical sectors, and since the size of each logical sector is 512 bytes, the size of each logical programming unit is 16 kilobyte (KB). If the basic access unit of the host system 1000 is 4 KB, the memory management circuit 1043 divides each logical programming unit into 4 logical management units.

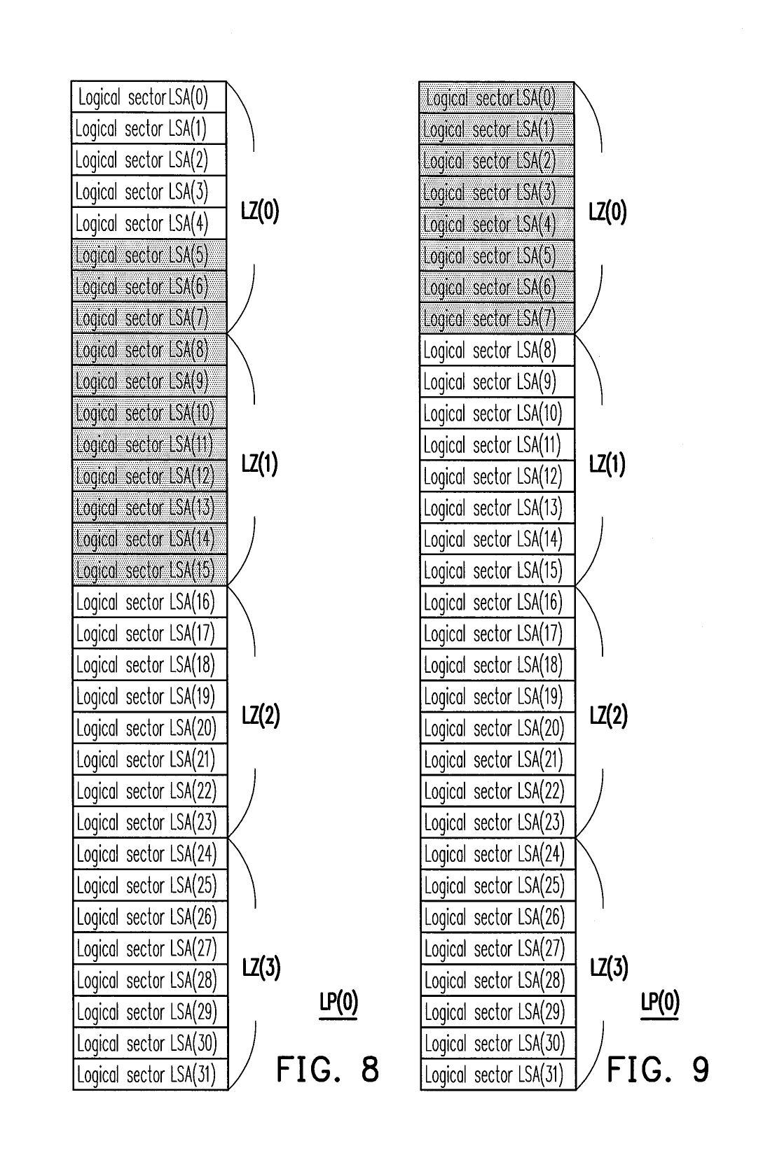

It is exemplified using the logical programming unit LP(0) as shown in FIG. 6, in which the logical programming unit LP(0) has logical sectors LSA(0) to LSA(31), and the memory management circuit 1043 divides the logical sectors LSA(0) to LSA(7) as a first logical management unit LZ(0), divides the logical sectors LSA(8) to LSA(15) as a second logical management unit LZ(1), divides the logical sectors LSA(16) to LSA(23) as a third logical management unit LZ(2), and divides the logical sectors LSA(24) to LSA(31) as a fourth logical management unit LZ(3). In which, a start address of the first logical management unit LZ(0) is at 0 byte and an end address thereof is at 4 KB. A start address of the second logical management unit LZ(1) is at 4 KB and an end address thereof is at 8 KB. A start address of the third logical management unit LZ(2) is at 8 KB and an end address thereof is at 12 KB. A start address of the fourth logical management unit LZ(3) is at 12 KB and an end address thereof is at 16 KB.

Since the size of each logical management unit is identical to the size of the basic access unit of the host system 1000, and the physical programming unit is required as the unit for programming the rewritable non-volatile memory module 106, thus in the exemplary embodiment of FIG. 6, four basic access units are included in the logical programming unit LP(0), indicating that up to four sets of data from different logical addresses may be written into each physical programming unit within the rewritable non-volatile memory module 106.

When the host system 1000 is intended to write data into the rewritable non-volatile memory module 106, if a data volume to be written is relatively small, it represents that the host system 1000 is intended to either simply write small piece of scattered data in the rewritable non-volatile memory module 106, or to update a partial content of a sequential data recorded in the rewritable non-volatile memory module 106. In the case where the host system 1000 is intended to update a partial content of the sequential data recorded in the rewritable non-volatile memory module 106, the chance for such sequential data being read by the host system 1000 later in a single operation is rather high. However, since the size of the basic access unit is smaller than the size of one logical programming unit, after a number of updates are performed to different address of a specific sequential data, such sequential data may be distributed and stored in different physical programming unit. As a result, when the host system 1000 is intended to read the sequential data later, the memory management circuit 1043 may spend a couple times more of busy time in order to have the sequential data completely read. More specifically, the rewritable non-volatile memory module 106 enters a busy state when a reading operation to each physical programming unit is performed by the memory management circuit 1043. In the busy state, other commands or additional operation may not be performed by the memory management circuit 1043, and the duration of such busy state is known as the busy time. It is exemplified using the structure of FIG. 6, if the host system 1000 is intended to read a sequential data with a size of 16 KB, the memory management circuit 1043 must perform reading operations to up to four different physical programming units in order to obtain the data completely. As a result, four times of the busy time is required in order to execute the read command issued by the host system 1000.

In order to prevent the reading speed from reducing due to the updated data and old valid data being stored in different physical programming units, continuity of data is increased by the memory management circuit 1043 through a method of filling data.

More specifically, when a data that the host system 1000 intended to be written into the rewritable non-volatile memory module 106 (hereinafter, the first data) is received by the memory storage device 100, the memory management circuit 1043 determines whether a logical start address of the first data is not aligned to a start address of each logical management unit within the logical programming unit being written. The memory management circuit 1043 further determines whether a logical end address of the first data is not aligned to an end address of each logical management unit within the first logical programming unit being written. If said logical start address is not aligned to the start address of each logical management unit and/or said logical end address is not aligned to the end address of each logical management unit, the memory management circuit 1043 fills the first data by using another data which is larger than the size of the basic access unit (hereinafter, the second data) to generate a write data and writes the write data into the rewritable non-volatile memory module 106. In other words, if a result to the foregoing determinations is positive, the first data which the host system 1000 is intended to write is written into the rewritable non-volatile memory module 106 after being filled with a second data which is larger than the basic access unit.

A couple of exemplary embodiments are illustrated below as to describe whether a filling process to the first data is performed by the memory management circuit 1043 when the host system is intended to write the first data into the logical programming unit LP(0) of FIG. 6.

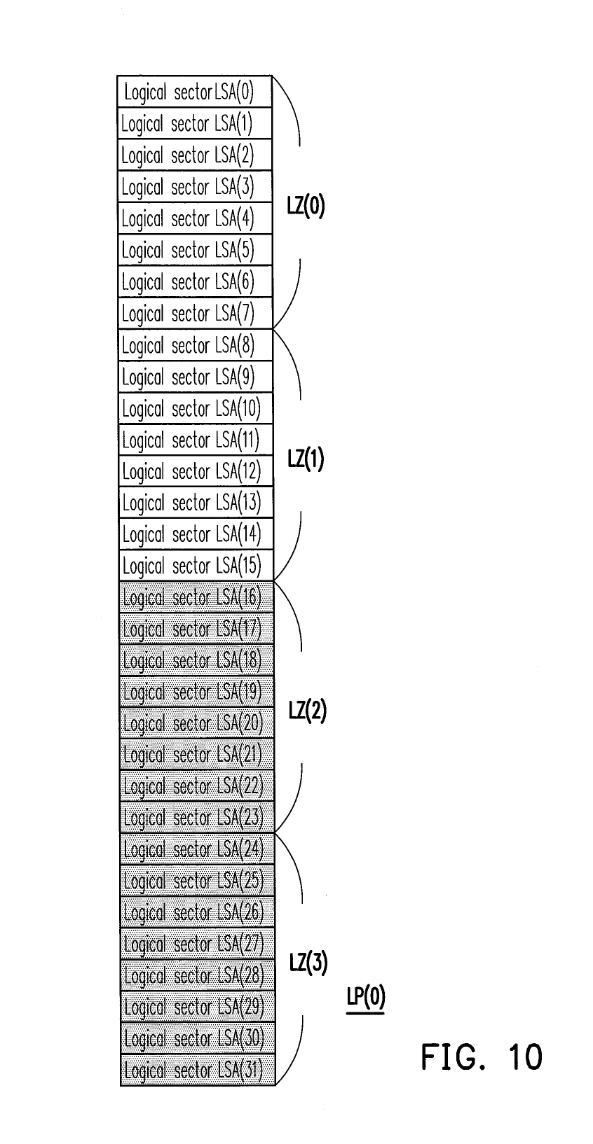

Referring to FIG. 7, it is assumed that the first data is written into logical sector LSA(3) to LSA (6) in the present exemplary embodiment. Since the logical start address of the first data is not aligned to any of the start address of the logical management units LZ(0) to LZ(3) and the logical end address of the first data is not aligned to any of the end addresses of the logical management units LZ(0) to LZ(3), the memory management circuit 1043 fills the first data by using the second data to generate the write data.

Referring to FIG. 8, the first data is written into the logical sectors LSA(5) to LSA(15) in the present exemplary embodiment. Although the logical end address of the first data is aligned to the end address of the logical management units LZ(1), however, the logical start address of the first data is not aligned to any of the start addresses of the logical management units LZ(0) to LZ(3), thus the memory management circuit 1043 still fills the first data by using the second data to generate the write data. In another exemplary embodiment, if the logical start address of the first data is aligned to the start address of a certain logical management unit (e.g., the logical management unit LZ(2)), but if the logical end address of the first data is not aligned to any of the end addresses of the logical management units LZ(0) to LZ(3), the memory management circuit 1043 also fills the first data by using the second data to generate the write data.

In the exemplary embodiment as shown in FIG. 9, the first data is written into the logical sectors LSA(0) to LSA(7). Since the logical start address and the logical end address are respectively aligned to the start address and the end address of the logical management unit LZ(0), the memory management circuit 1043 directly uses the first data as the write data for writing into the rewritable non-volatile memory module 106 without performing a filling process to the first data.

In an exemplary embodiment, the second data used to fill the first data by the memory management circuit 1043 is stored in the physical programming unit mapped with the logical programming unit which the first data is written therein. In this case, the memory management circuit 1043 identifies, according to the logical address-physical address mapping table, the physical programming unit PP(0) mapped with the logical programming unit LP(0) corresponding to the first data, and then the memory management circuit 1043 pre-reads the second data from the physical programming unit PP(0).

For example, when the first data is filled by the memory management circuit 1043 for matching to the size of one physical programming unit (i.e., a data volume of the write data is identical to a size of one physical programming unit), the second data is the data in the other physical sectors of the physical programming unit PP(0) which is not corresponding to the logical sector where the first data is written into. For example, it is assumed that the logical sectors LSA(0) to LSA(31) in the logical programming unit LP(0) of FIG. 6 are corresponding to the physical sectors PSA(0) to PSA(31) in the physical programming unit PP(0). In this case, the second data is the data in the physical sectors PSA(0) to PSA(2), PSA(7) to PSA(31) of the physical programming unit PP(0) in the exemplary embodiment as shown in FIG. 7. Whereas in the exemplary embodiment of FIG. 8, the second data is the data in the physical sectors PSA(0) to PSA(4), PSA(16) to PSA(31) of the physical programming unit PP(0). By filling the first data with said method and write it into a physical programming unit, when the host system 1000 is intended to read a entire section of sequential address that contains the first data, the sequential data may be read in a single operation without perform reading operations to multiple physical programming units.

It should be noted that, in another exemplary embodiment, the data volume of the write data may be smaller than the size of one physical programming unit. For example, when the data volume of the write data is three quarters of the size of one physical programming unit, the memory management circuit 1043, for example, pre-reads the data in the physical sectors PSA(0) to PSA(2), PSA(7) to PSA(23) of the physical programming unit PP(0) as the second data in the exemplary embodiment as shown in FIG. 7. Whereas in the exemplary embodiment of FIG. 8, the memory management circuit 1043, for example, pre-reads the data in the physical sectors PSA(0) to PSA(4), PSA(16) to PSA(23) of the physical programming unit PP(0) as the second data.

In yet another exemplary embodiment, the data volume of the write data may exceed the size of one physical programming unit, for example, the data volume of the write data may be identical to the size of two physical programming unit. The size of the write data in the invention is not limited by the above embodiments, that is, it falls in the scope of the invention as long as the data volume of the second data for filling is larger than the basic access unit.

In addition, when the host system 1000 intended to write a sequential data into the rewritable non-volatile memory module 106, the chance for such sequential data being read by the host system 1000 again in the further in a single operation is rather high. In this case, in another exemplary embodiment of the invention, the memory management circuit 1043 determines whether the first data is a sequential data when receiving the first data from host system 1000. If the data is a sequential data, regardless of whether the logical start address and the logical end address of the first data are aligned with any of the start and end addresses of the logical management units, the memory management circuit 1043 fills the first data by using the second data which is larger then the basic access unit to generate the write data.

For example, the memory management circuit 1043 may determine whether the first data is a sequential data by comparing the data volume of the first data reaches a data volume threshold. If the data volume reaches the data volume threshold, the memory management circuit 1043 determines the first data as a sequential data. For the convenience of illustration, it is assumed that the data volume threshold is twice the size of the basic access unit. In the exemplary embodiment as shown in FIG. 10, the first data is written into the logical sectors LSA(16) to LSA(31) of the logical programming unit LP(0), and since the data volume of the first data is twice the size of the basic access unit, the first data is determined as a sequential data. In this case, even though the logical start address of the first data is aligned to the start address of logical management unit LZ(2) and the logical end address of the first data is aligned to the end address of the logical management unit LZ(3), the memory management circuit 1043 still fills the first data with a second data which is larger than the basic access unit, so as to generate the write data for writing into the rewritable non-volatile memory module 106. In which, the second data may be, for example, the data in the physical sectors PSA(0) to PSA(15) of the physical programming unit PP(0) mapped with the logical programming unit LP(0). In addition, if the first data is written into the logical sectors LSA(8) to LSA(23) of the logical programming unit LP(0), the memory management circuit 1403, for example, uses the data in the physical sectors PSA(0) to PSA(7), PSA(24) to PSA(31) of the physical programming unit PP(0) as the second data. In the present exemplary embodiment, the manner of pre-reading the second data has to meet the purpose of filling the first data until its size reaches the size of one physical programming unit (i.e., the data volume of the write data is identical to the size of one physical programming unit). However, the data volume of the second data is not limited thereto, it falls in the scope of the invention as long as the data volume of the second data is larger tan the basic access unit.

in yet another exemplary embodiment of the invention, the memory management circuit 1043 determines whether a used size of the rewritable non-volatile memory module 106 exceeds a usage threshold after receiving the first data from the host system 1000. If the used size exceeds the usage threshold, which indicates that the memory storage device 100 is about to run out of space for storing data, and the user may need to read the data from the memory storage device 100 and backup the data to other storage devices very soon. Under this circumstance, the memory management circuit 1043 directly uses the second data to fill the first data to generate the write data. That is, regardless of whether the logical start address and the logical end address of the first data are aligned with any of the start and end addresses of the logical management unit, a filling operation is performed on the first data by the memory management circuit 1043. Base on above method, the speed of the follow-up reading operation may be increased.

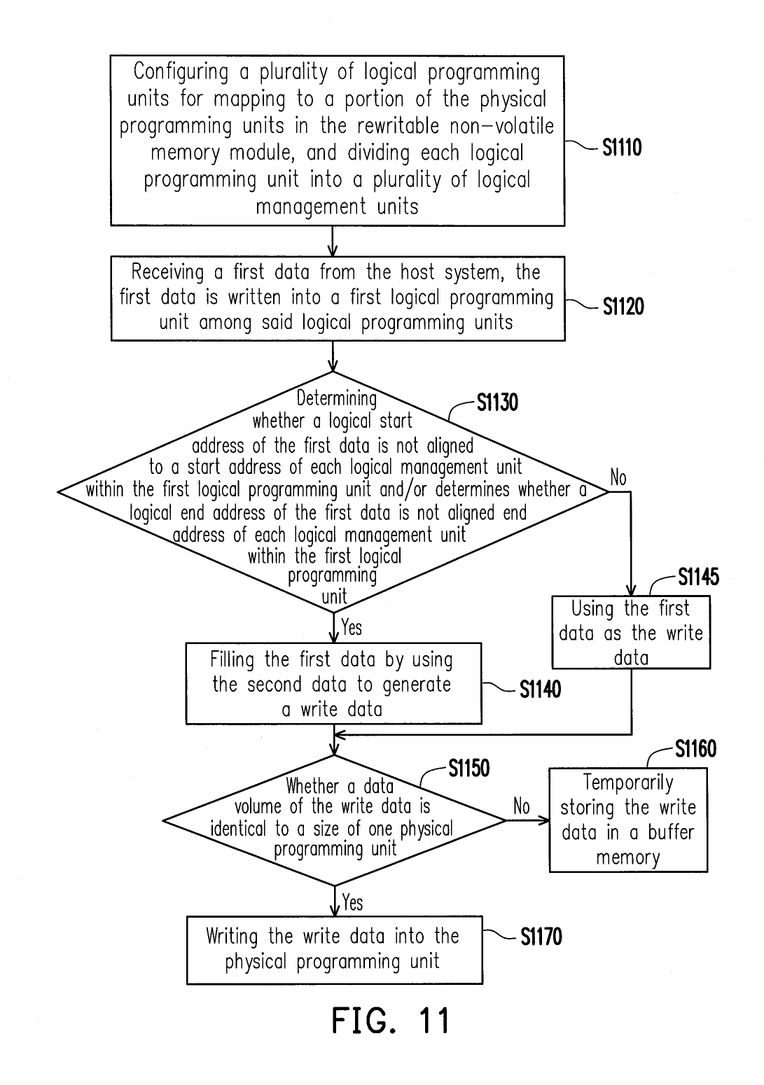

FIG. 11 is a flowchart illustrating a method for writing data according to an embodiment of the invention.

Referring to FIG. 11, the memory management circuit 1043 configures a plurality of logical programming units for mapping to a portion of the physical programming units in the rewritable non-volatile memory module 106, and divides each logical programming unit into a plurality of logical management units, as shown in step S1110.

Next in step S1120, the memory management circuit 1043 receives a first data from the host system 1000, the first data is written into a first logical programming unit.

As shown in step S1130, the memory management circuit 1043 determines whether a logical start address of the first data is not aligned to a start address of each logical management unit within the first logical programming unit and/or determines whether a logical end address of the first data is not aligned to an end address of each logical management unit within the first logical programming unit.

If a result to the determination in the step S1130 is positive, the memory management circuit 1043 fill the first data by using the second data to generate a write data in the step S1140.

If the determination result of the step S1130 is negative, the memory management circuit 1043 directly uses the first data as the write data in the step S1145. It is noted that, if the first data is smaller than one physical programming unit, the memory management circuit 1043 fills the first data until it is identical to the size of the physical programming unit as the write data.

Since the programming of the rewritable non-volatile memory module 106 requires the physical programming unit as the unit, this in step S1150, the memory management circuit 1043 determines whether a data volume of the write data is identical to a size of one physical programming unit.

If the data volume of the write data is not reach the size of one physical programming unit, the memory management circuit 1043 temporarily stores the write data in a buffer memory 3004 and waits until the volume of data in the buffer memory 3004 reaches the size of one physical programming unit caused by receiving other writing command from the host system 1000, then practically writes the data in the buffer memory 3004 to the rewritable non-volatile memory module 106, as shown in step S1160.

However, if the data volume of the write data is already reached the size of one physical programming unit, as shown in step S1170, the memory management circuit 1043 writes the write data into the physical programming unit.

In view of above, when the host system is intended to write data into the memory storage device, the method for writing data, the memory storage device and the memory controller of the invention is capable of determining whether a logical start address and a logical end address of the data are not aligned to the start and end addresses of each logical management unit in the logical programming unit. If a result to the foregoing determinations is positive, another data which is larger than the basic access unit may be pre-read from the rewritable non-volatile memory module for filling, and then the filled data may be written into the rewritable non-volatile memory module. Based on above, a continuity of the write data written to the physical programming unit may be ensured, thereby increasing the speed of reading data in the follow-up operations. However, the advantages aforementioned are not required in all versions of the invention.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed:

1. A method for writing data, adapted for a rewritable non-volatile memory module, the rewritable non-volatile memory module has a plurality of physical erasing units, and each of the physical erasing units has a plurality of physical programming units, the method comprises:
configuring a plurality of logical programming units for mapping to a portion of the physical programming units in the rewritable non-volatile memory module, and dividing each of the logical programming units into a plurality of logical management units, wherein a size of each of the logical management units is identical to a size of a basic access unit of a host system;
receiving a first data from the host system, wherein the first data is written into a first logical programming unit among the logical programming units;
determining whether a logical start address of the first data is not aligned to a start address of each of the logical management units within the first logical programming unit and/or determining whether a logical end address of the first data is not aligned to an end address of each of the logical management units within the first logical programming unit;
if a result to the foregoing determinations is positive, filling the first data by using a second data which is larger than the size of the basic access unit of the host system to generate a write data; and
writing the write data into at least one of the physical programming units.

2. The method for writing data of claim 1, wherein after the step of receiving the first data from the host system, further comprising:
determining whether the first data is a sequential data; and
if the first data is the sequential data, directly performing the step of filling the first data by using the second data to generate the write data.

3. The method for writing data of claim 2, wherein the step of determining whether the first data is the sequential data comprises:
when a data volume of the first data reaches a data volume threshold, the first data is determined as the sequential data.

4. The method for writing data of claim 1, wherein after the step of receiving the first data from the host system, further comprising:
determining whether a used size of the rewritable non-volatile memory module exceeds a usage threshold; and
if the used size exceeds the usage threshold, directly performing the step of filling the first data by using the second data to generate the write data.

5. The method for writing data of claim 1, wherein the second data is pre-read from a physical programming unit mapped with the first logical programming unit.

6. The method for writing data of claim 1, wherein a data volume of the write data is identical to a size of one physical programming unit.

7. A memory controller, adapted for a memory storage device having a rewritable non-volatile memory module, the memory controller comprises:
a host system interface, configured for coupling to a host system;
a memory interface, configured for coupling to the rewritable non-volatile memory module, wherein the rewritable non-volatile memory module has a plurality of physical erasing units, and each of the physical erasing units has a plurality of physical programming units; and
a memory management circuit coupled to the host system interface and the memory interface, configured for configuring a plurality of logical programming units for mapping to a portion of the physical programming units in the rewritable non-volatile memory module, and dividing each of the logical programming units into a plurality of logical management units, wherein a size of each of the logical management units is identical to a size of a basic access unit of the host system,
wherein the memory management circuit is further configured for receiving a first data from the host system, wherein the first data is written into a first logical programming unit among the logical programming units,
wherein the memory management circuit is further configured for determining whether a logical start address of the first data is not aligned to a start address of each of the logical management units within the first logical programming unit and/or determining whether a logical end address of the first data is not aligned to an end address of each of the logical management units within the first logical programming unit,
if a result to the foregoing determinations is positive, the memory management circuit is further configured for filling the first data by using a second data which is larger than the size of the basic access unit of the host system to generate a write data, and writing the write data into at least one of the physical programming units.

8. The memory controller of claim 7, wherein the memory management circuit is further configured for determining whether the first data is a sequential data after receiving the first data from the host system,
if the first data is the sequential data, the memory management circuit is further configured for directly filling the first data by using the second data to generate the write data.

9. The memory controller of claim 8, wherein the memory management circuit determines the first data as the sequential data when a data volume of the first data reaches a data volume threshold.

10. The memory controller of claim 7, wherein the memory management circuit is further configured for determining whether a used size of the rewritable non-volatile memory module exceeds a usage threshold after receiving the first data from the host system,
if the used size exceeds the usage threshold, the memory management circuit is further configured for directly filling the first data by using the second data to generate the write data.

11. The memory controller of claim 7, wherein the second data is pre-read from a physical programming unit mapped with the first logical programming unit.

12. The memory controller of claim 7, wherein a data volume of the write data is identical to a size of one physical programming unit.

13. A memory storage device, comprising:
a rewritable non-volatile memory module, the rewritable non-volatile memory module has a plurality of physical erasing units, and each of the erasing units has a plurality of physical programming units;
a connector, configured for coupling to a host system; and
a memory controller coupled to the rewritable non-volatile memory module and the connector, configured for configuring a plurality of logical programming units for mapping to a portion of the physical programming units in the rewritable non-volatile memory module, and dividing each of the logical programming units into a plurality of logical management units, wherein a size of each of the logical management units is identical to a size of a basic access unit of the host system,
wherein the memory controller is further configured for receiving a first data from the host system, wherein the first data is written into a first logical programming unit among the logical programming units,
wherein the memory controller is further configured for determining whether a logical start address of the first data is not aligned to a start address of each of the logical management units within the first logical programming unit and/or determining whether a logical end address of the first data is not aligned to an end address of each of the logical management units within the first logical programming unit,
if a result to the foregoing determinations is positive, the memory controller is further configured for filling the first data by using a second data which is larger than the size of the basic access unit of the host system to generate a write data, and writing the write data into at least one of the physical programming units.

14. The memory storage device of claim 13, wherein the memory controller is further configured for determining whether the first data is a sequential data after receiving the first data from the host system,
if the first data is the sequential data, the memory controller is further configured for directly filling the first data by using the second data to generate the write data.

15. The memory storage device of claim 14, wherein the memory controller determines the first data as the sequential data when a data volume of the first data reaches a data volume threshold.

16. The memory storage device of claim 13, wherein the memory controller is further configured for determining whether a used size of the rewritable non-volatile memory module exceeds a usage threshold after receiving the first data from the host system,
if the used size exceeds the usage threshold, the memory controller is further configured for directly filling the first data by using the second data to generate the write data.

17. The memory storage device of claim 13, wherein the second data is pre-read from a physical programming unit mapped with the first logical programming unit.

18. The memory storage device of claim 13, wherein a data volume of the write data is identical to a size of one physical programming unit.
